(19) United States
(12) Patent Application Publication
(10) Pub. No.: US 2026/0061645 A1
(43) Pub. Date: Mar. 5, 2026

(54) ROTARY ELECTRIC SHAVER

(71) Applicant: MAXELL IZUMI CO., LTD., Matsumoto-shi (JP)

(72) Inventors: Yuta SUGIURA, Matsumoto-shi (JP); Yoshiaki YOSHIIKE, Matsumoto-shi (JP); Koichi ODAGIRI, Matsumoto-shi (JP)

(21) Appl. No.: 19/260,607

(22) Filed: Jul. 7, 2025

(30) Foreign Application Priority Data
Sep. 5, 2024 (JP) 2024-152998

(51) Int. Cl. B26B 19/14; B26B 19/38

(52) U.S. Cl. CPC B26B 19/141; B26B 19/386

(57) ABSTRACT

A rotary electric shaver includes a head connected to the main body. The head includes an outer blade part and an inner blade part. The inner blade part includes a plurality of inner blades and a base part in which the inner blades are disposed around the first axis, and the inner blades come into sliding contact with a sliding contact surface of the outer blade. In the outer blade, an outer area in which a first r-curved portion following a top part is circled and an inner area in which a second r-curved portion following the top part is circled are continuous, and the first r-curved portion is longer than the second r-curved portion.

### CROSS-REFERENCE TO RELATED APPLICATION

This application is based upon and claims the benefit of priority of the prior Japanese Patent Application No. P2024-152998, filed on Sep. 5, 2024, and the entire contents of which are incorporated herein by reference.

### TECHNICAL FIELD

The present invention relates to a rotary electric shaver.

### BACKGROUND ART

In the related art, a rotary electric shaver including a donut-shaped outer blade and a plurality of inner blades that come in sliding contact with a sliding contact surface of the outer blade has been proposed (PTL 1: JPH08-196753A and PTL 2: JPH08-196754A). In addition, in the related art, a rotary electric shaver including a blade unit including an outer blade having an annular shaving surface on an outer side and an inner blade that comes into sliding contact with a sliding contact surface of the outer blade is known (PTL 3: JP-A-2015-070927).

### SUMMARY OF INVENTION

### Technical Problem

Since an outer area in an outer blade is formed in an r-curved shape in a rotary electric shaver, the rotary electric shaver has an advantage that a smoother touch on the skin is achieved during shaving. However, according to configurations disclosed in PTL 1 and PTL 2, a center of the outer blade is deeply recessed. Consequently, when an inner blade is in sliding contact with the outer blade, frictional resistance increases, and rotation of the inner blade is slowed down. In addition, an increase in frictional resistance between the outer blade and the inner blade causes a decrease in a service life of the outer blade. According to a configuration disclosed in PTL 3 in which a plurality of blade units are disposed, compared to a configuration including one blade unit, it is significantly more difficult to increase a size of the outer blade.

### Solution to Problem

The present invention is made in view of the above-described circumstances, and an object of the present invention is to provide a rotary electric shaver having a configuration which enables an outer blade to have a longer service life while achieving a smoother touch on the skin during shaving.

The present invention has been accomplished under the solutions as disclosed below.

According to an aspect of the present invention, there is provided a rotary electric shaver including a main body including an electric motor for driving a first shaft, and a head connected to the main body. The head includes a blade unit, the blade unit includes an outer blade part and an inner blade part, the outer blade part includes an outer blade in which a plurality of holes are formed around a first axis, the inner blade part includes a plurality of inner blades and a base part in which the inner blades are disposed around the first axis, the first shaft is connected to the base part, the inner blades come into sliding contact with a sliding contact surface of the outer blade, in the outer blade, an outer area in which a first r-curved portion following a top part is circled and an inner area in which a second r-curved portion following the top part is circled are continuous, and the first r-curved portion is longer than the second r-curved portion.

According to this configuration, the outer area having a higher peripheral velocity is wider than the inner area of the sliding contact surface of the outer blade. Therefore, shaving can be performed over a wide range by an action of a centrifugal force applied to the inner blade in conjunction with rotation of the base part. The inner area having a lower peripheral velocity is narrower than the outer area of the sliding contact surface of the outer blade, and frictional resistance can be reduced. Therefore, hairs can be smoothly cut. In this invention, examples of the hairs include beards, mustache, whisker, and the like. In addition, since the frictional resistance between the outer blade and the inner blade is reduced, a longer service life of the outer blade can be achieved.

As an example, the outer blade is made of an electroformed body, and a plurality of holes having a size through which the hairs can enter are formed. The holes are provided as a single type of minute holes penetrating in slit shapes or round holes penetrating in circular shapes or in elliptical shapes, or a combination of a plurality of types thereof. As shapes of the holes, a round hole, a rhombic shape, a quadrangular shape, a triangular shape, or other known geometric shapes can be adopted. As types of the holes, one type or a combination of two or more types can be adopted.

As an example, a thickness of the first r-curved portion is larger than a thickness of the second r-curved portion. According to this configuration, the thickness of the outer area having a higher peripheral velocity than the inner area of the sliding contact surface of the outer blade is larger, whereby it can be easy to improve strength of the outer area which is easier to be worn due to influence of the centrifugal force than the inner area. The thickness of the inner area which is less likely to be worn than the outer area is smaller, whereby followability to the skin during shaving can be easily improved.

As an example, the inner blade is mounted at a position closer to an outer side than half a radius of the base part with respect to the first axis, and a blade edge of the inner blade has a shape that matches the first r-curved portion and the second r-curved portion. According to this configuration, the peripheral velocity of the inner blade is increased to improve cutting ability to cut the hairs, and the inner blade is brought into sliding contact with a wide range to enable smooth shaving. In addition, since the frictional resistance between the outer blade and the inner blade is reduced, a longer service life of the outer blade can be achieved.

As an example, the inner blade includes a support part that supports the blade edge, and the inner blade part includes a leaf spring that pushes the support part toward the sliding contact surface. According to this configuration, both a force of pushing the sliding contact surface by using a restoring force of the leaf spring and a force of pushing the inner blade in an outer peripheral direction of the outer blade by using the centrifugal force are applied. Therefore, the inner blade is brought into sliding contact with a wide range to enable smooth shaving.

As an example, the main body includes a grip part, a blade setting base, and a second shaft, the blade setting base is connected to the grip part to be tiltable via a connection part, the head includes a setting part in which a plurality of the blade units are disposed and a blade frame that holds the setting part, the blade frame is connected to the blade setting base, the outer blade part includes a disk-shaped cover disposed at a central position of the outer blade, a receiving portion that supports the first shaft is formed inside the cover, the second shaft is connected to the first shaft, and the electric motor is connected to the second shaft. According to this configuration, even in a configuration in which the plurality of blade units are disposed, each inner blade of each blade unit is stably rotated, and excellent shaving performance is achieved even for a severely uneven portion from a jaw to a face.

As an example, the first shaft may be an output shaft itself of the electric motor. In this case, since the output shaft can be directly connected to the base part, the number of components can be significantly reduced. A compact and simple configuration can be made. As an example, in some cases, the blade unit may be provided as a single unit, and a plurality of the blade units may be provided.

According to another aspect of the present invention, there is provided a rotary electric shaver including a main body including an electric motor for driving a first shaft, and a head connected to the main body. The head includes a blade unit, the blade unit includes an outer blade part and an inner blade part, the outer blade part includes an outer blade in which a plurality of holes are formed around a first axis, the inner blade part includes a plurality of inner blades and a base part in which the inner blades are disposed around the first axis, the first shaft is connected to the base part, the inner blades come into sliding contact with a sliding contact surface of the outer blade, a blade edge of the inner blade has a shape that matches an r-curved shape of an outer area in the outer blade, and the inner blades are mounted at a position closer to an outer side than half a radius of the base part with respect to the first axis.

According to this configuration, the peripheral velocity of the inner blade is increased to improve cutting ability to cut the hairs, and the inner blade is brought into sliding contact with a wide range to enable smooth shaving. Since the inner blade does not come into sliding contact with an area close to the first axis of the sliding contact surface of the outer blade, frictional resistance can be reduced. Therefore, the hairs can be smoothly cut. In addition, since the frictional resistance between the outer blade and the inner blade is reduced, a longer service life of the outer blade can be achieved.

### Advantageous Effects of Invention

According to the present invention, it is possible to realize a rotary electric shaver having a configuration which enables an outer blade to have a longer service life while achieving a smoother touch on the skin during shaving.

### BRIEF DESCRIPTION OF DRAWINGS

FIG. 1 is a schematic perspective view showing an example of a rotary electric shaver according to a first embodiment of the present invention.

FIG. 2 is a schematic front view of the rotary electric shaver shown in FIG. 1.

FIG. 3 is a schematic longitudinal sectional view when the rotary electric shaver shown in FIG. 1 is viewed from a side surface.

FIG. 4 is an enlarged view of a part surrounded by a broken line E in FIG. 3.

FIG. 5 is an enlarged view showing an outer blade part in FIG. 3 in an enlarged manner.

FIG. 6 is an enlarged view showing an inner blade part in FIG. 3 in an enlarged manner.

FIG. 7 is a schematic structural development view of a head of the rotary electric shaver shown in FIG. 1.

FIG. 8 is a schematic front view showing a first example of a rotary electric shaver according to a second embodiment of the present invention.

FIG. 9 is a schematic longitudinal sectional view when the rotary electric shaver shown in FIG. 8 is viewed from a side surface.

FIG. 10 is a schematic front view showing a second example of the rotary electric shaver according to the second embodiment of the present invention.

FIG. 11 is a schematic longitudinal sectional view when the rotary electric shaver shown in FIG. 10 is viewed from a side surface.

FIG. 12A is a schematic plan view of a donut-shaped outer blade part according to the above-described embodiment. FIG. 12B is a schematic front view of the donut-shaped outer blade part according to the above-described embodiment. FIG. 12C is a schematic bottom view of the donut-shaped outer blade part according to the above-described embodiment.

FIG. 13A is a schematic plan view of a dome-shaped outer blade part according to the above-described embodiment. FIG. 13B is a schematic front view of the dome-shaped outer blade part according to the above-described embodiment. FIG. 13C is a schematic bottom view of the dome-shaped outer blade part according to the above-described embodiment.

### DESCRIPTION OF EMBODIMENTS

Hereinafter, an embodiment of the present invention will be described in detail with reference to the drawings. The present embodiment is a hand-held rotary electric shaver 1 including a head 3 in which one or three blade units 4 are disposed. Here, in order to easily describe a positional relationship between respective parts of the rotary electric shaver 1, directions are indicated by arrows of X, Y, and Z in the drawing. When the rotary electric shaver 1 is actually used, without being limited to these directions, the shaver may be used in any orientation. In all drawings for describing the embodiment, the same reference numerals will be assigned to members having the same function, and repeated description thereof may be omitted in some cases.

### First Embodiment

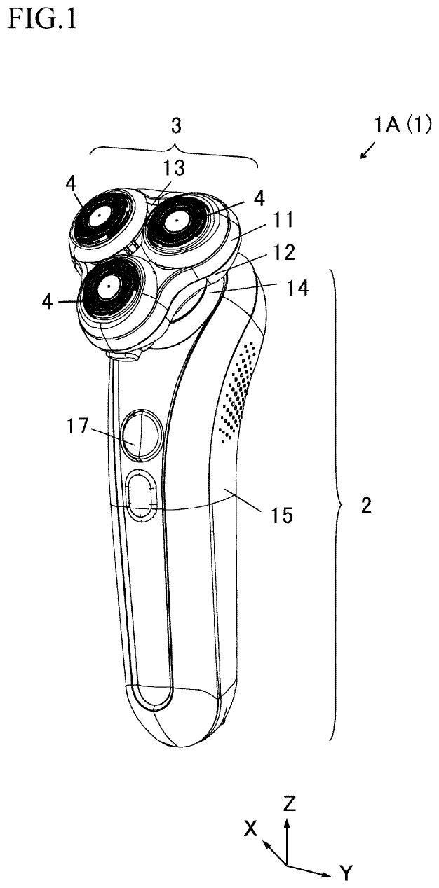

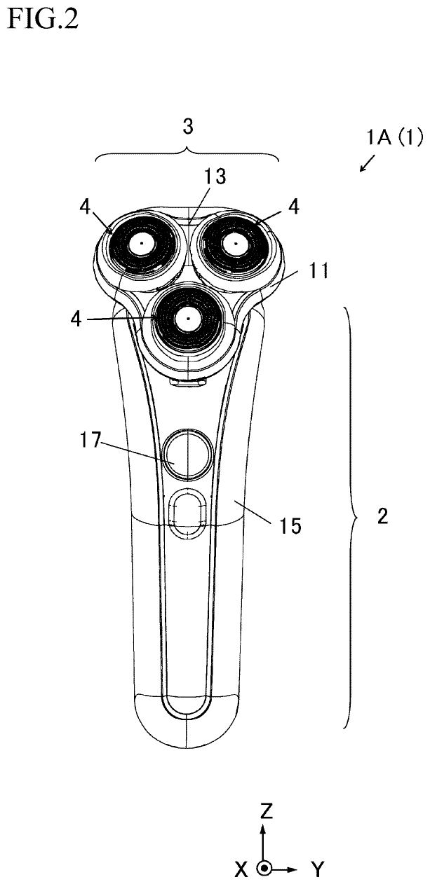

As shown in FIGS. 1 and 2, a rotary electric shaver 1A of a first embodiment includes the head 3 in which three blade units 4 are disposed. The present embodiment has the following configuration. A second shaft 8b and a first shaft 8a are rotated by a rotational force of an electric motor 9, and the rotational force is transmitted to a base part 6b in which an inner blade 6a is disposed. In this manner, the base part 6b is rotated. The number of the blade units 4 may be two, four, or more.

In examples in FIGS. 1 and 2, a front surface side of a main body 2 is an operation panel, and a push-button type power switch 17 is disposed. As an example, a blade setting base 12 is connected to a grip part 15 via a connection part 14, and the head 3 is configured to be tiltable with respect to the main body 2.

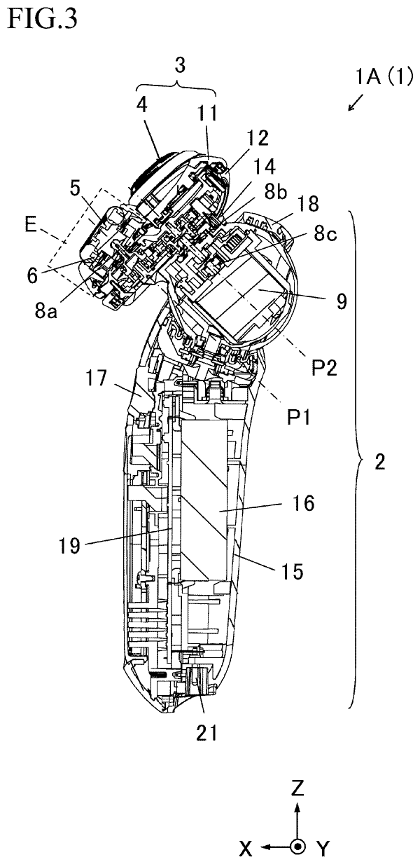

As shown in FIGS. 1 to 3, the main body 2 includes the grip part 15 gripped by a user, and the head 3 detachably connected to the connection part 14 provided in the grip part 15. A trimmer 18 is disposed on a back surface side of the main body 2. The main body 2 is internally equipped with the electric motor 9, a battery 16 capable of supplying direct current power to the electric motor 9, and a controller 19 that is activated by the power switch 17 to perform driving control of the electric motor 9. As an example, a configuration is adopted as follows. A power supply terminal 21 is disposed in a lower part on the back surface side of the main body 2, and power can be supplied to the battery 16 from an external power source via the power supply terminal 21. As an example, an output shaft 8c of the electric motor 9 is connected to the second shaft 8b in a second drive unit including a plurality of gears. The second shaft 8b is a second driven shaft. A technology in the related art can be applied to the second drive unit.

A plurality of the first shafts 8a are disposed in the blade setting base 12, and as an example, three first shafts 8a are disposed at a predetermined interval. As an example, the second shaft 8b is connected to the first shaft 8a in a first drive unit including a plurality of gears. Therefore, the second shaft 8b is connected to the first shaft 8a, and the electric motor 9 is connected to the second shaft 8b. A technology in the related art can be applied to the first drive unit.

The head 3 includes a mounting part 13 in which the three blade units 4 are disposed at a predetermined interval, and a blade frame 11 that holds the mounting part 13. As an example, the mounting part 13 has the following configuration. An intermediate position between one blade unit 4 and another blade unit 4 has a groove shape, and the blade unit 4 is swingable by the groove shape. In addition, the mounting part 13 is configured to be biased and pushed up due to a restoring force of a plate-shaped spring 41 disposed in the blade frame 11.

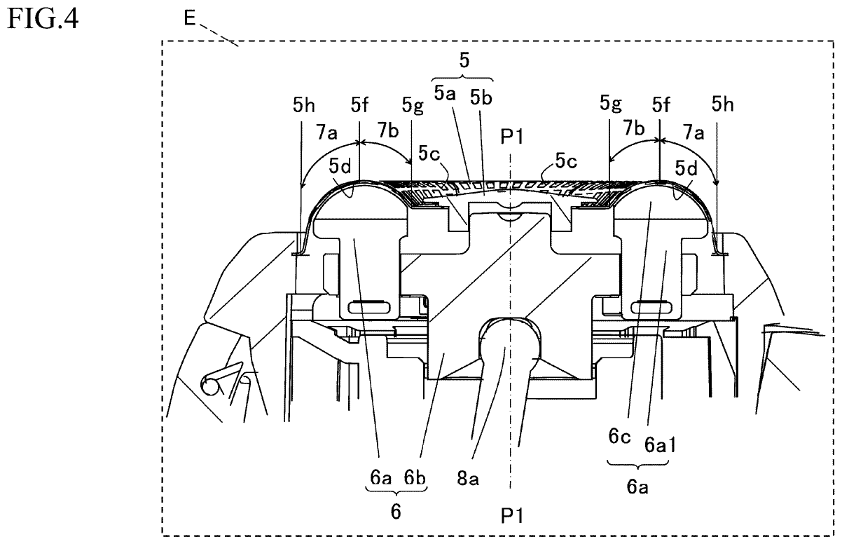

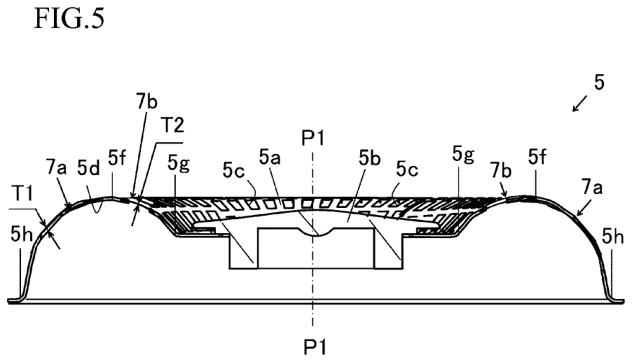

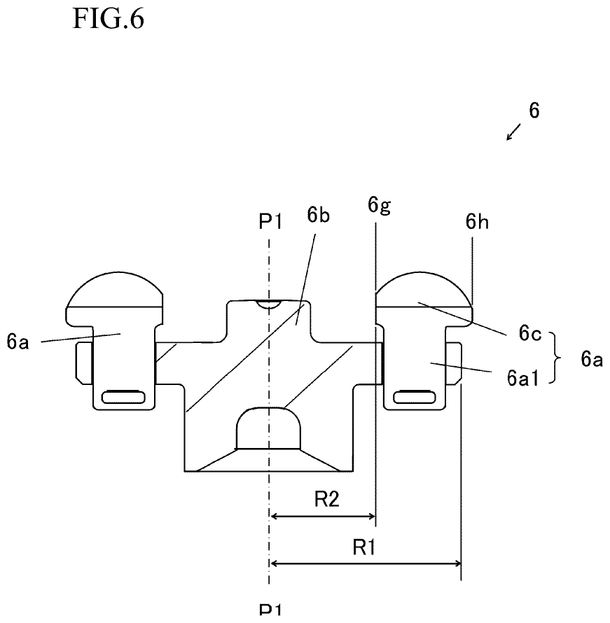

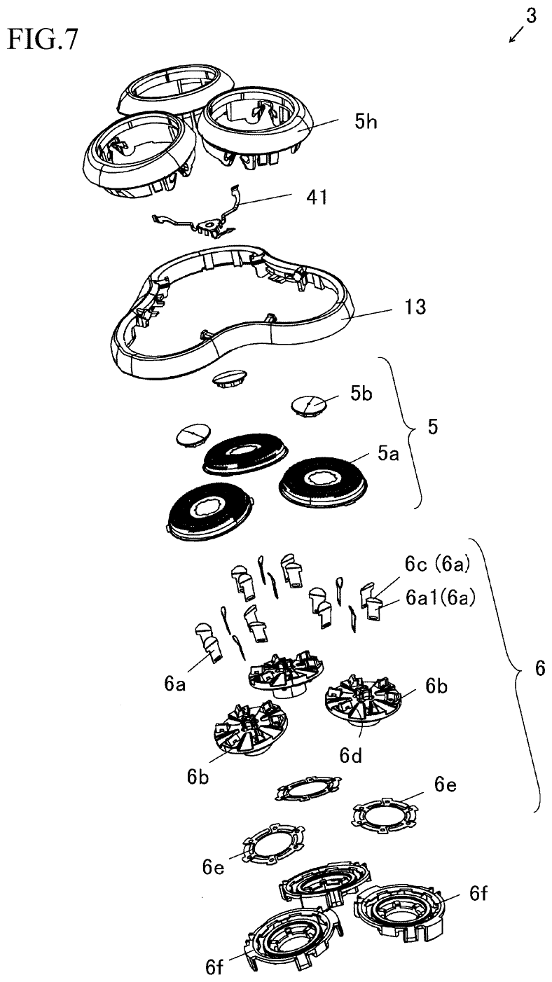

FIG. 4 is an enlarged view of a part surrounded by a broken line E in the head 3 according to the present embodiment. FIG. 5 is an enlarged view showing an enlarged outer blade part 5 of the head 3. FIG. 6 is an enlarged view showing an enlarged inner blade part 6 in the head 3. FIG. 7 is a schematic structural development view of the head 3. Each of the blade units 4 includes the outer blade part 5 and the inner blade part 6. As an example, the outer blade part 5 includes a donut-shaped or annular outer blade 5a and a disk-shaped cover 5b. The outer blade 5a includes an outer surface and an inner sliding contact surface 5d with which a blade edge 6c of the inner blade 6a comes into sliding contact, and a plurality of slit-shaped holes 5c or round holes 5c having a size through which the hairs can enter are formed. The outer blade 5a is a metal component in which the plurality of holes 5c are formed in a circumferential direction.

The cover 5b made of a resin or metal is mounted to the outer blade part 5 on a first axis P1 passing through a center of the outer blade 5a. A protrusion is provided on the first axis P1 in a lower portion of the cover 5b, and a recess is provided on the first axis P1 in an upper portion of the base part 6b. The protrusion and the recess are combined to more accurately position the outer blade 5a and the inner blade 6a with respect to the first axis P1. The outer blade part 5 may have a shape in which the center of the outer blade 5a is closed without providing the cover 5b.

The outer blade 5a is made of an electroformed body. The outer blade 5a is manufactured by performing an electroforming process in which thick plating such as nickel plating is performed on a surface of a master model, the thick plating is peeled off from the master model, and the outer blade 5a is formed. The electroforming process enables the outer blade 5a to be strong, thin, and highly accurate. As an example, the electroformed body is formed to have two or more layers.

The inner blade part 6 includes the plurality of inner blades 6a and the resin-made base part 6b in which the metal-made inner blades 6a are disposed at a predetermined interval around the first axis P1. As an example, three to eight inner blades 6a are mounted on the base part 6b. As an example, six inner blades 6a are mounted on the base part 6b. A window portion is fitted to a protrusion portion of the base part 6b such that each of the inner blades 6a can maintain an erected posture. The inner blade 6a is movable within a range of more than 0 mm to 0.25 mm in a left and right direction and a front and rear direction, and is configured as follows. Self-centering is available while the blade edge 6c comes into sliding contact with the sliding contact surface 5d in conjunction with a rotational operation of the base part 6b. That is, the inner blade 6a is configured to be movable in a direction in which a frictional force between the blade edge 6c and the sliding contact surface 5d is suppressed. As an example, the inner blade 6a is made of stainless steel, a nickel alloy, or another known metal or alloy.

As shown in FIG. 7, the inner blade 6a includes a support part 6a1 that supports the blade edge 6c, and the blade edge 6c is bent with respect to the support part 6a1. The inner blade part 6 includes a leaf spring 6e that pushes the support part 6a1 toward the sliding contact surface 5d. The leaf spring 6e has an annular shape, and is in contact with a lower surface of the support part 6a1. The leaf spring 6e simultaneously pushes the respective inner blades 6a of the respective base parts 6b toward the sliding contact surface 5d. In this manner, the inner blade 6a can be brought into sliding contact with a wide range to enable smooth shaving by using both the force of pushing the sliding contact surface 5d by the restoring force of the leaf spring 6e and the force of pushing the inner blade 6a in the outer peripheral direction of the outer blade 5a by the centrifugal force. When the outer blade 5a is brought into close contact with the skin to trim hairs of an uneven portion such as a chin, the outer blade 5a and the blade edge 6c are brought into close contact with the uneven portion to trim the hairs while being elastically deformed. Therefore, the hairs can be smoothly cut. As an example, in the inner blade 6a, the blade edge 6c is bent with respect to the support part 6a1 in a forward moving direction.

In the base part 6b, a groove part 6d inclined downward in a radial direction is formed in a radial shape. Shaving waste cut by sliding contact between the outer blade 5a and the inner blade 6a is efficiently discharged outward of the base part 6b through the downward inclined groove part 6d by actions of the self weight of the shaving waste and the centrifugal force applied to the shaving waste. Therefore, it is possible to prevent accumulation of the shaving waste that hinders the rotational operation of the base part 6b.

A recess is formed in a central lower portion of the base part 6b, and a tip portion of the first shaft 8a is fitted and connected to the recess. The second shaft 8b is connected to the first shaft 8a, and the electric motor 9 is connected to the second shaft 8b. Therefore, when the power switch 17 is pushed, the controller 19 is activated, the electric motor 9 is operated under the control of the controller 19, and the base part 6b is rotated around the first axis P1 passing through the first shaft 8a in conjunction with the drive shaft of the electric motor 9, the second shaft 8b, the first shaft 8a, and the base part 6b.

In the examples shown in FIGS. 4 and 5, in the outer blade 5a, an outer area in which a first r-curved portion 7a following a top part 5f is circled and an inner area in which a second r-curved portion 7b following the top part 5f is circled are continuous. In the present embodiment, the first r-curved portion 7a is longer than the second r-curved portion 7b. In this manner, the outer area having the higher peripheral velocity than the inner area of the sliding contact surface 5d of the outer blade 5a becomes wider. Therefore, the shaving can be performed over a wide range by the action of the centrifugal force applied to the inner blade 6a in conjunction with the rotation of the base part 6b. The inner area having the lower peripheral velocity than the outer area of the sliding contact surface 5d of the outer blade 5a becomes narrower, and the frictional resistance can be reduced. Therefore, the hairs can be smoothly cut.

The outer area in the present specification is a part further separated from the first axis P1 than the inner area on the outer side following the top part 5f, and means a part in which the plurality of holes 5c for introducing the hairs are formed, and with which the inner blade 6a comes into sliding contact. The inner area in the present specification is a part closer to the first axis P1 than the outer area on the inner side following the top part 5f, and means a part in which the plurality of holes 5c for introducing the hairs are formed, and with which the inner blade 6a comes into sliding contact.

As an example, with regard to an opening area, a total size of all of the holes 5c in the outer area following the top part 5f is larger than a total size of all of the holes 5c in the inner area following the top part 5f. That is, the opening area of the outer peripheral area is larger than the opening area of the inner peripheral area. According to this configuration, even when many hairs enter the holes 5c of the outer area to increase cutting resistance, a satisfactory shearing force can be easily secured by the above-described centrifugal force. Elements that affect the opening area are the size of each hole 5c, a rib width, and the number of the holes 5c.

As an example, in the outer blade 5a, the opening area of each hole 5c in the outer area following the top part 5f is larger than the opening area of each hole 5c in the inner area following the top part 5f. That is, the opening area of each hole 5c in an outer peripheral area is larger than the opening area of each hole 5c in an inner peripheral area. According to this configuration, even when many hairs enter the opening of the outer area to increase the cutting resistance, the satisfactory shearing force can be easily secured by the above-described centrifugal force. Elements that affect the opening area are the size of each hole 5c, a rib width, and the number of the holes 5c.

The outer blade 5a is made of an electroformed body. As shown in FIG. 5, a first thickness T1 which is the thickness of the first r-curved portion 7a is larger than a second thickness T2 which is the thickness of the second r-curved portion 7b. According to this configuration, the thickness of the outer area having the higher peripheral velocity than the inner area of the sliding contact surface 5d of the outer blade 5a is larger. In this manner, it is possible to easily improve strength of the outer area which is more likely to be worn than the inner area due to the influence of the centrifugal force applied to the inner blade 6a. The thickness of the inner area which is less likely to be worn than the outer area is smaller. In this manner, followability to the skin during shaving can be easily improved.

The holes 5c are provided as a single type of minute holes penetrating in slit shapes or round holes penetrating in circular shapes or in elliptical shapes, or a combination of a plurality of types thereof. As shapes of the holes 5c, a round hole, a rhombic shape, a quadrangular shape, a triangular shape, or other known geometric shapes can be adopted. As types of the holes 5c, one type or a combination of two or more types can be adopted.

As shown in FIGS. 5 and 6, the inner blade 6a is mounted at a position closer to the outer side than half a first radius R1 which is a radius of the base part 6b with respect to the first axis P1. That is, a second radius R2 from the first axis P1 to an inner end 6g of the inner blade 6a is larger than half the first radius R1. The blade edge 6c of the inner blade 6a has an r-curved shape that matches the first r-curved portion 7a and the second r-curved portion 7b. Furthermore, an outer end 6h of the inner blade 6a is mounted at a position outside the first radius R1. According to this configuration, the peripheral velocity of the inner blade 6a is increased to improve the cutting ability to cut the hairs, and the inner blade 6a is brought into sliding contact with a wide range to enable smooth shaving.

Next, a first example of a second embodiment will be described below. Here, the same reference numerals will be assigned to members having the same functions as those in the first embodiment.

### First Example of Second Embodiment

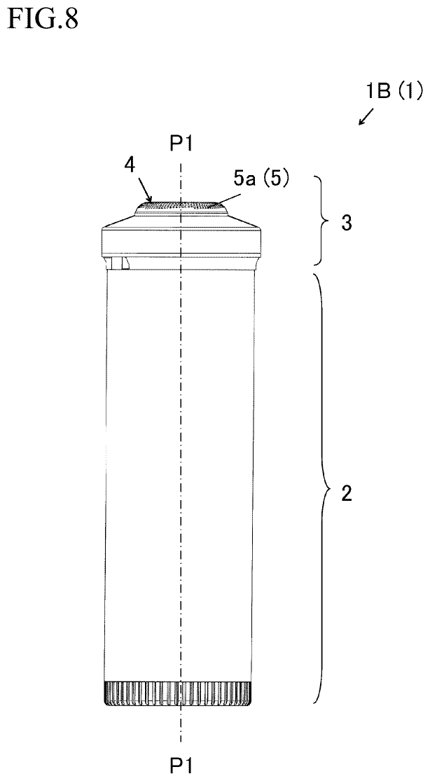

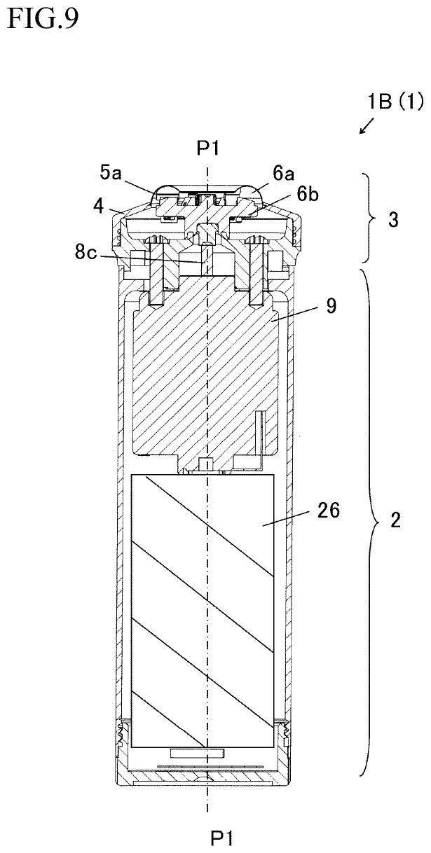

As shown in FIGS. 8 and 9, a rotary electric shaver 1B of the first example of the second embodiment includes the head 3 in which one blade unit 4 is disposed. The present embodiment adopts the following configuration. The output shaft 8c of the electric motor 9 is directly connected to the base part 6b, and the base part 6b is rotated by directly transmitting the rotational force of the electric motor 9. That is, the second embodiment adopts a configuration without providing the first shaft 8a and the second shaft 8b in the first embodiment, and adopts a configuration in which the output shaft 8c fulfills a function of the first shaft 8a.

The main body 2 has a cylindrical shape or a straight shape which is likely to be gripped by a user. As an example, the main body 2 includes a bottom portion which is a detachable lid body, and is used by detaching the lid body, setting a dry cell 26, attaching the lid body, and turning on a power switch installed on a side surface of the main body 2. According to this configuration, the main body 2 can be easily formed in a shape which is likely to be gripped with fingers.

In the first example, the outer blade part 5 includes the donut-shaped or annular outer blade 5a. The outer blade 5a is made of an electroformed body, and a plurality of holes having a size through which the hairs can enter are formed. The inner blade part 6 includes the plurality of inner blades 6a and the base part 6b in which the inner blades 6a are disposed at a predetermined interval around the first axis P1. The technique of the first embodiment described above can be applied to the outer blade part 5 and the inner blade part 6.

Subsequently, a second example of the second embodiment will be described below. Here, the same reference numerals will be assigned to members having the same functions as those in the first embodiment.

### Second Example of Second Embodiment

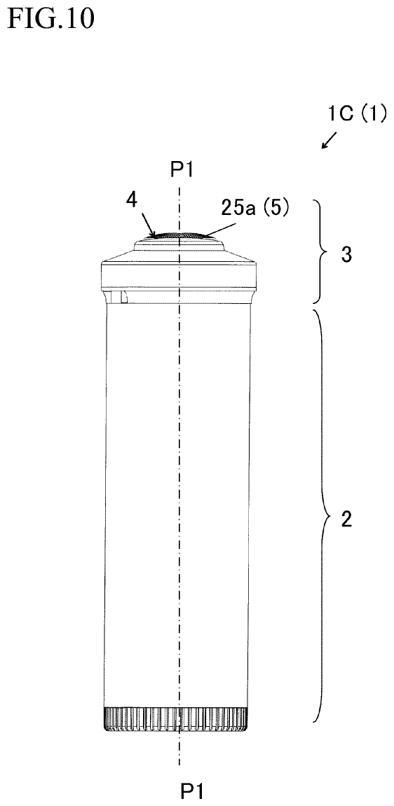

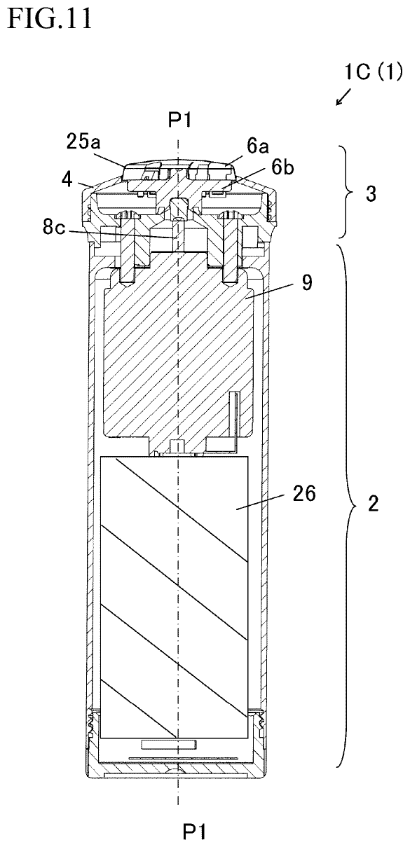

As shown in FIGS. 10 and 11, a rotary electric shaver 1C of the second example of the second embodiment includes the head 3 in which one blade unit 4 is disposed. The present embodiment adopts the following configuration. The output shaft 8c of the electric motor 9 is directly connected to the base part 6b, and the base part 6b is rotated by directly transmitting the rotational force of the electric motor 9. A structure of the main body 2 in the second example is the same as that in the first example.

In the second example, the outer blade part 5 includes a dome-shaped or hemispherical outer blade 25a. The outer blade 25a is made of an electroformed body, and a plurality of holes having a size through which the hairs can enter are formed. The inner blade part 6 includes the plurality of inner blades 6a and the base part 6b in which the inner blades 6a are disposed at a predetermined interval around the first axis P1. The technique of the first embodiment described above can be applied to the outer blade part 5 and the inner blade part 6.

Subsequently, the donut-shaped outer blade part 5 in the embodiment of the present invention will be described below.

### First Example

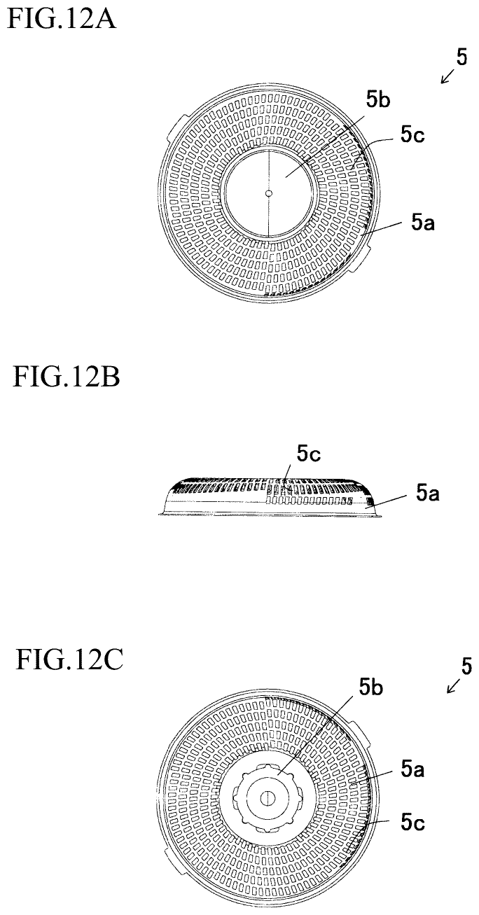

As shown in FIGS. 12A to 12C, the outer blade part 5 includes the donut-shaped or annular outer blade 5a and the disk-shaped cover 5b. The outer blade 5a is made of an electroformed body having a two-layer structure or a multilayer structure. A main material of the outer blade 5a is nickel or a nickel alloy, and an outer layer made of palladium or a palladium alloy is formed on the outer side of a main material layer. The outer side of a palladium layer is subjected to a chromic acid treatment. Surface roughness is reduced by the palladium layer, and a touch on the skin is improved. Oxidization of a surface is prevented by the chromic acid treatment, and a longer service life is achieved.

As an example, the first thickness T1 of the first r-curved portion 7a in the outer blade 5a is 50 to 150 μm. As an example, the first thickness T1 is 75 to 125 μm. As an example, the first thickness T1 is 90 to 110 μm.

The first thickness T1 is larger than the second thickness T2 of the second r-curved portion 7b. As an example, the first thickness T1 is larger than the second thickness T2 by 10 to 25 μm. As an example, the first thickness T1 is larger than the second thickness T2 by 5 to 20 μm.

Next, the dome-shaped outer blade part 5 in the embodiment of the present invention will be described below.

### Second Example

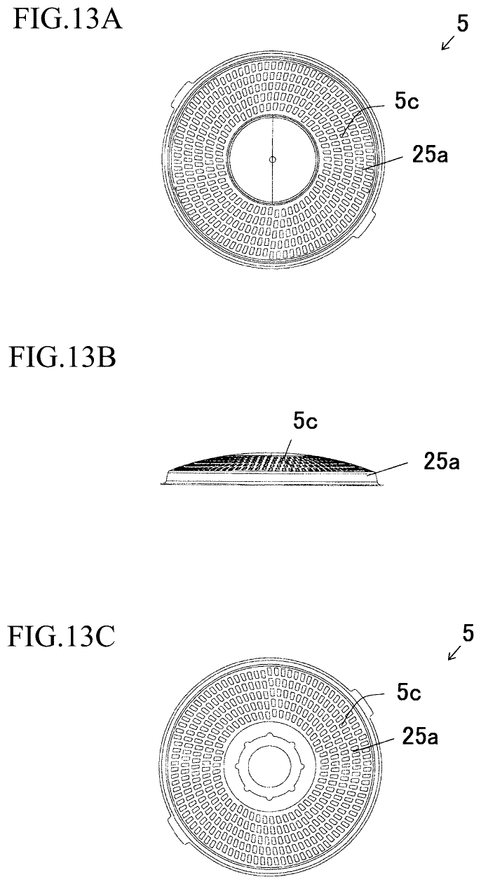

As shown in FIGS. 13A to 13C, the outer blade part 5 includes the dome-shaped or hemispherical outer blade 25a. The outer blade 5a is made of an electroformed body having a two-layer structure or a multilayer structure. As described above, the peripheral velocity of the inner blade 6a is increased to improve the cutting ability to cut the hairs, and the inner blade 6a is brought into sliding contact with a wide range to enable smooth shaving.

According to each of the above-described configurations, it is possible to obtain the rotary electric shaver 1 having a configuration which enables the outer blade to have a longer service life while achieving a smoother touch on the skin during shaving. The present invention is not limited to the embodiments described above, and various modifications can be made within the scope not departing from the present invention.

What is claimed is:

1. A rotary electric shaver comprising:
a main body including an electric motor for driving a first shaft; and
a head connected to the main body,
wherein the head includes a blade unit, the blade unit includes an outer blade part and an inner blade part, the outer blade part includes an outer blade in which a plurality of holes are formed around a first axis, the inner blade part includes a plurality of inner blades and a base part in which the inner blades are disposed around the first axis, the first shaft is connected to the base part, the inner blades come into sliding contact with a sliding contact surface of the outer blade, in the outer blade, an outer area in which a first r-curved portion following a top part is circled and an inner area in which a second r-curved portion following the top part is circled are continuous, and the first r-curved portion is longer than the second r-curved portion.

2. The rotary electric shaver according to claim 1, wherein the inner blade is mounted at a position closer to an outer side than half a radius of the base part with respect to the first axis, and a blade edge of the inner blade has a shape that matches the first r-curved portion and the second r-curved portion.

3. The rotary electric shaver according to claim 2, wherein the inner blade includes a support part that supports the blade edge, and the inner blade part includes a leaf spring that pushes the support part toward the sliding contact surface.

4. The rotary electric shaver according to claim 1, wherein the outer blade is made of an electroformed body, and a thickness of the first r-curved portion is larger than a thickness of the second r-curved portion.

5. The rotary electric shaver according to claim 1, wherein the main body includes a grip part, a blade setting base, and a second shaft, the blade setting base is connected to the grip part to be tiltable via a connection part, the head includes a setting part in which a plurality of the blade units are disposed, and a blade frame that holds the setting part, the blade frame is connected to the blade setting base, in the outer blade part, a disk-shaped cover is disposed at a central position of the outer blade, a receiving portion that supports the first shaft is formed inside the cover, the second shaft is connected to the first shaft, and the electric motor is connected to the second shaft.

6. A rotary electric shaver comprising:
a main body including an electric motor for driving a first shaft; and
a head connected to the main body,
wherein the head includes a blade unit, the blade unit includes an outer blade part and an inner blade part, the outer blade part includes an outer blade in which a plurality of holes are formed around a first axis, the inner blade part includes a plurality of inner blades and a base part in which the inner blades are disposed around the first axis, the first shaft is connected to the base part, the inner blades come into sliding contact with a sliding contact surface of the outer blade, a blade edge of the inner blade has a shape that matches an r-curved shape of an outer area in the outer blade, and the inner blades are mounted at a position closer to an outer side than half a radius of the base part with respect to the first axis.

7. The rotary electric shaver according to claim 6, wherein the inner blade includes a support part that supports the blade edge, and the inner blade part includes a leaf spring that pushes the support part toward the sliding contact surface.
